(19) United States
(12) Patent Application Publication
(10) Pub. No.: US 2009/0327971 A1
(43) Pub. Date: Dec. 31, 2009

(54) INFORMATIONAL ELEMENTS IN THREAT MODELS

(75) Inventors: Adam Shostack, Seattle, WA (US); Ivan Medvedev, Bellevue, WA (US); Meng Li, Bellevue, WA (US); Douglas Maclver, Seattle, WA (US); Patrick Glen McCuller, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/146,548

(22) Filed: Jun. 26, 2008

(51) Int. Cl. G06F 3/048

(52) U.S. Cl. 715/853

(57) ABSTRACT

Excluding selected elements in a data flow diagram from a threat model. The selected elements are marked as informational. An automated threat modeling system generates a threat model report for the elements in the data flow diagram except for the elements marked as informational. Excluding the informational elements from the threat model and threat model report reduces the complexity of the threat analysis and enables a modeler to focus the threat model on elements of interest.

### BACKGROUND

Threat modeling often includes the analysis of a data flow diagram. Data flow diagrams describe the movement of information in an information system such as a software system, the sources of information, what processes occur on the information, where the information is stored, and where the information eventually flows. Data flow diagrams should be simple but complete. However, it is often difficult to fully describe the context of the information system being modeled without adding elements that are not the focus of the model. For example, the information system being modeled may comprise one process that is designed to exchange data with a plurality of other processes, or the system may represent one small component of an application, an operating system, or other larger system. The relationship between the information system being modeled and other entities may not be obvious from the data flow diagram of just the information system.

To provide a larger view of the information system, modelers describe the context and environment of the information system in the data flow diagram. However, by including the context and environment, the complexity of the analysis of the threats and mitigations of the data flow diagram increases significantly because each element in the data flow diagram is considered a threat target. Referred to as a threat explosion or proliferation, the threat analysis produces a proliferation of irrelevant threats that distract the modeler and model reviewers from the potential threats associated with the information system.

### SUMMARY

Embodiments of the invention enable elements in a data flow diagram to be excluded from a threat analysis. In some embodiments, one or more elements in the data flow diagram are marked as informational. In response to a request for a threat model, the elements marked as informational are excluded from the generation of the threat model or excluded from the threat model report. In some embodiments, the informational elements are distinguishable from the other elements in a visual representation of the data flow diagram.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a user interacting with a threat modeling system.

FIG. 2 is an exemplary block diagram of a computing device having a memory area storing a representation of a data flow diagram.

FIG. 3 is an exemplary flow chart illustrating the identification of informational elements in a threat model.

FIG. 4 is an exemplary flow chart illustrating the exclusion of informational elements when generating a threat model.

FIG. 5 is an exemplary user interface illustrating a data flow diagram.

FIG. 6 is an exemplary user interface illustrating the data flow diagram of FIG. 5 with the addition of elements providing context.

FIG. 7 is an exemplary user interface illustrating a generated threat model listing the elements providing context as threats.

FIG. 8 is an exemplary user interface illustrating the identification of the elements providing context as informational elements.

FIG. 9 is an exemplary user interface illustrating the informational elements distinguished from the other elements in the data flow diagram.

FIG. 10 is an exemplary user interface illustrating a generated threat model listing the elements providing context as informational elements.

FIG. 11 is an exemplary user interface illustrating an analysis report with the informational elements listed separately from the other elements.

FIG. 12 is an exemplary block diagram illustrating a sample data flow diagram.

Corresponding reference characters indicate corresponding parts throughout the drawings.

### DETAILED DESCRIPTION

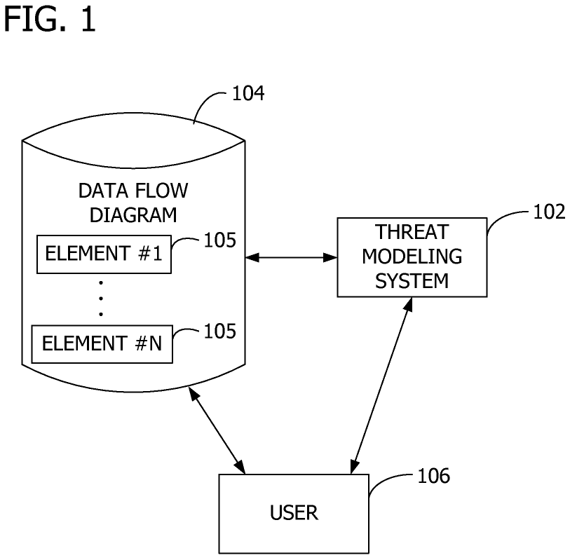

Embodiments of the invention enable elements 105 in a data flow diagram 104 to be excluded from a threat analysis. In some embodiments, one or more of the elements 105 such as element #1 through element #N are designated, selected, tagged, marked, or otherwise indicated as informational elements, where N is a positive integer value. The informational elements represent elements 105 that are contextual or for informational purposes in the data flow diagram 104. In some embodiments, the informational elements are visually distinguishable from other elements 105 in a visual representation of the data flow diagram 104. In a testing environment such as shown in FIG. 1 in which the information system includes an application program, a data flow diagram 104 corresponding to the application program is analyzed by an automated threat modeling system 102. The threat modeling system 102 identifies elements 105 of the data flow diagram 104 that pose potential security threats to the application program, but excludes the informational elements during creation of a threat model or from a threat model report. During analysis of the threat model, the informational elements are ignored and deemed to not pose a potential threat. The potential security threats are reported to a test engineer or other user 106. By reducing the quantity of false threats or threats of no interest to the user 106, aspects of the invention save user time and enable faster review of threat models, among other advantages.

While aspects of the invention are described with reference to threat modeling for application programs, aspects of the invention are operable generally with information systems including software systems having one or more application programs, processes, and/or data stores.

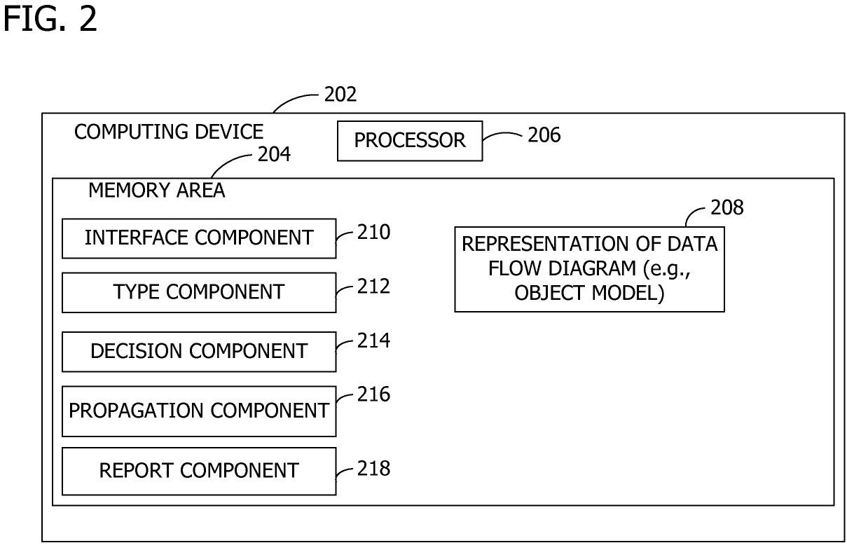

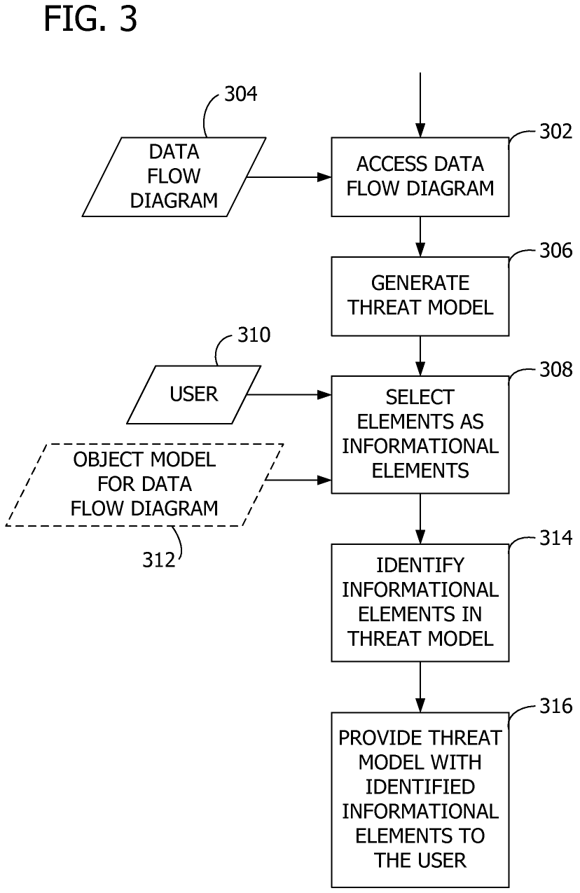

Referring next to FIG. 2, an exemplary block diagram shows a computing device 202 having a memory area 204 storing a representation 208 of a data flow diagram such as data flow diagram 104 from FIG. 1. The data flow diagram 104 includes a plurality of the elements 105 arranged to describe a flow of data through an information system. The computing device 202 has at least one processor 206. In an embodiment, the processor 206 is transformed into a special purpose microprocessor by executing computer-executable instructions or by otherwise being programmed. For example, the processor 206 is programmed with instructions such as illustrated in FIG. 3 to identify the informational elements in a threat model report. The representation 208 of the data flow diagram 104 for the information system from 304 is accessed at 302. A threat model is generated at 306 based on the plurality of elements 105. One or more elements from the plurality of elements 105 are selected at 308 as informational elements. For example, the user 106 may select the informational elements at 310 or, optionally, the informational elements may be indicated in an object model for the data flow diagram 104 at 312. The informational elements are identified in the generated threat model at 314. At 316, the generated threat model with the identified informational elements is provided to the user 106 for analysis.

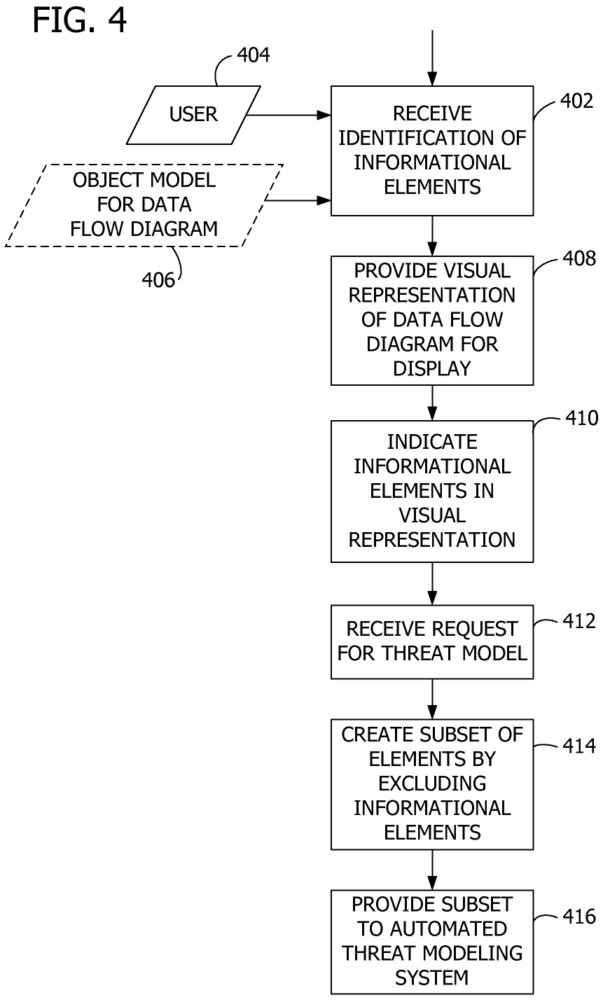

While the operations in FIG. 3 describe the identification of the informational elements in the threat model, other methods for treating the informational elements differently from other elements 105 are within the scope of the invention. For example, FIG. 4 describes the exclusion of the informational elements from the threat model.

Referring again to FIG. 2, the memory area 204 or other computer-readable medium stores computer-executable components for marking elements 105 in the data flow diagram 104 as informational. The components execute to cascade, propagate, spread, or otherwise identify other elements 105 as informational elements based on predefined criteria. The operations described and illustrated with reference to FIG. 2 are optionally implemented in some embodiments. The propagation may occur in an automated fashion based on the relationships between the elements 105. Exemplary components include an interface component 210, a type component 212, a decision component 214, a propagation component 216, and a report component 218. The interface component 210 accesses the representation 208 of the data flow diagram 104 for an information system. The data flow diagram 104 includes the plurality of elements 105, of which one or more are marked as informational. The type component 212 identifies, from the plurality of elements 105, one or more data flow elements adjacent to at least one of the informational elements. The decision component 214 determines whether the data flow elements identified by the type component 212 cross a trust boundary. As an example, the decision component 214 determines whether each of the data flow elements identified by the type component 212 crosses a trust boundary by determining whether a level of trust changes across the data flow element.

The propagation component 216 indicates or marks the data flow elements as informational based on the determination by the decision component 214. For example, aspects of the invention mark one of the elements 105 as informational when the element 105 is a data flow element, is adjacent to an informational element, and does not cross a trust boundary. In contrast, aspects of the invention will mark one of the elements 105 as “not informational” (or leave the element 105 unmarked) when the element 105 is a data flow element, is adjacent to an element 105 marked “not informational,” and does not cross a trust boundary.

In some embodiments, the propagation component 216 indicates the data flow elements as “informational” or “not informational” by setting a property value for each of data flow elements in an object model. Appendix A includes an example excerpt of extensible markup language (XML) code in which a property labeled “informational” is set to TRUE or FALSE.

The report component 218 generates a threat model for each of the plurality of elements 105. The interface component 210 provides the data flow diagram 104 and/or the generated threat model to the user 106 for display. In some embodiments, the elements 105 indicated to be informational are visually distinguished in the threat model and/or the data flow diagram 104 from the other elements 105. For example, the informational elements may be a different color, grayed-out, or the like.

Referring next to FIG. 4, an exemplary flow chart illustrates the exclusion of informational elements when generating a threat model. One or more informational elements in the data flow diagram 104 are identified at 402. For example, the user 106 may identify the informational elements at 404 or, optionally, the informational elements may be identified in an object model corresponding to the data flow diagram 104 at 406. For example, the status of the elements 105 is stored as a property value associated with the elements 105. In some embodiments, the property value is stored in a file (e.g., extensible markup language file) associated with the data flow diagram 104. At 408, a visual representation of the data flow diagram 104 is provided to the user 106 for display. The informational elements are indicated in the provided visual representation at 410. For example, the informational elements are in a different color, font, size, or other visual appearance sufficient to visually distinguish the other elements 105 in the data flow diagram 104.

A request for a threat model is received from the user 106 at 412. Alternatively, the threat model may be automatically created (e.g., upon accessing the data flow diagram 104, or at a predefined time). A subset of the plurality of elements 105 in the data flow diagram 104 is created at 414 by excluding the informational elements. That is, the subset contains all the elements 105 in the data flow diagram 104 except for the informational elements. The subset of elements 105 is provided to the threat modeling system 102 at 416. The threat modeling system 102 generates the threat model using the subset of elements 105.

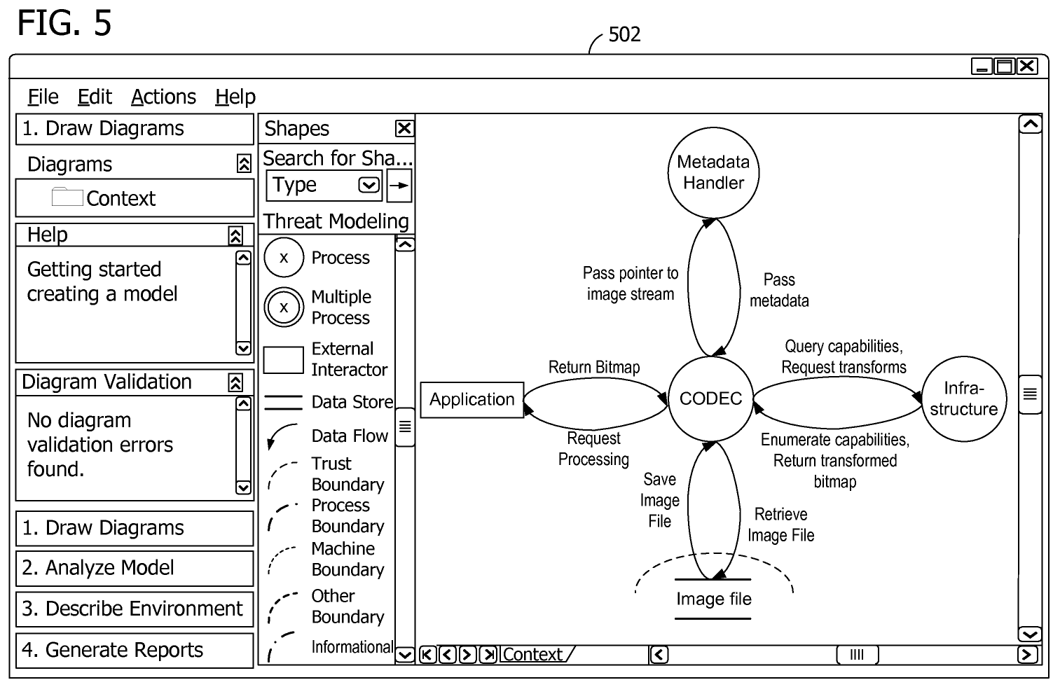

Referring next to FIG. 5, an exemplary user interface 502 illustrates an exemplary data flow diagram. The exemplary user interface 502 is associated, for example, with the threat modeling system 102 or other threat modeling tool. The exemplary data flow diagram in the user interface 502 corresponds to a compressor-decompressor (CODEC) and has four types of elements 105: process, external interactor, data flow, and data store. However, for the purposes of this example, the data flow diagram in FIG. 5 is presumed to not provide enough context describe the operation of the elements 105. As an example, the data flow diagram in FIG. 5 does not indicate that the image file will be modified by another process

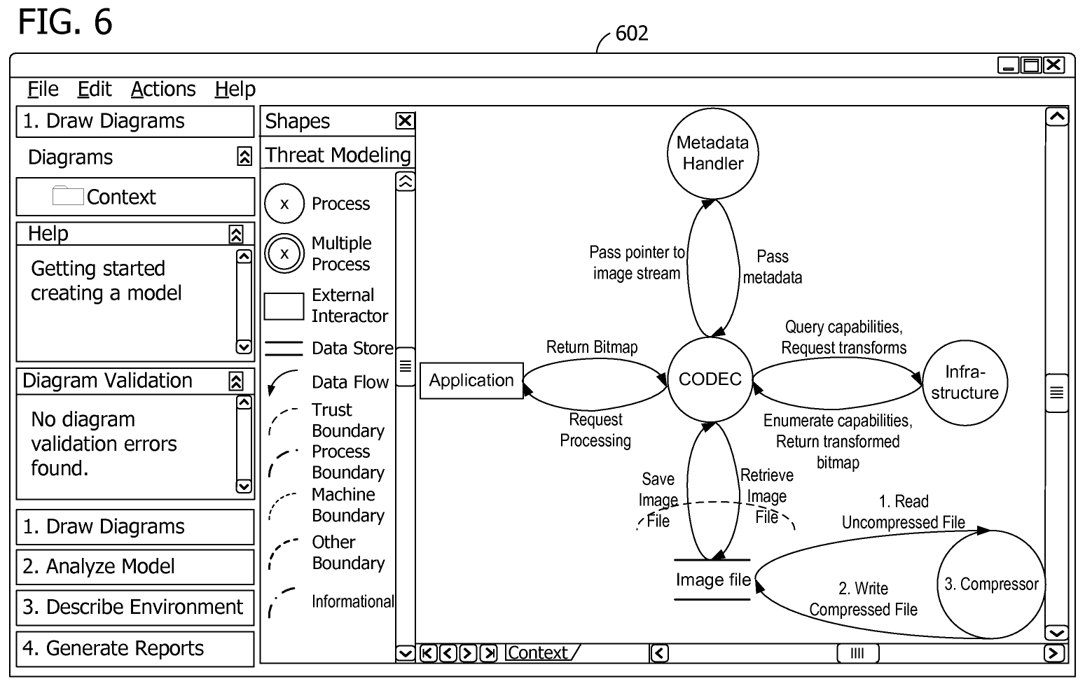

Referring next to FIG. 6, an exemplary user interface 602 illustrates the data flow diagram of FIG. 5 with the addition of elements 105 providing context. The compressor element, read uncompressed file element, and write compressed file element have been added to the data flow diagram of FIG. 5 to show context. However, the data flow diagram has been expanded with the additional elements 105, and the completeness of the corresponding threat model now depends on identifying and certifying, or mitigating and tracking additional threats (e.g., the threats relating to the elements 105 added to the data flow diagram of FIG. 5) which are not themselves important in the CODEC model.

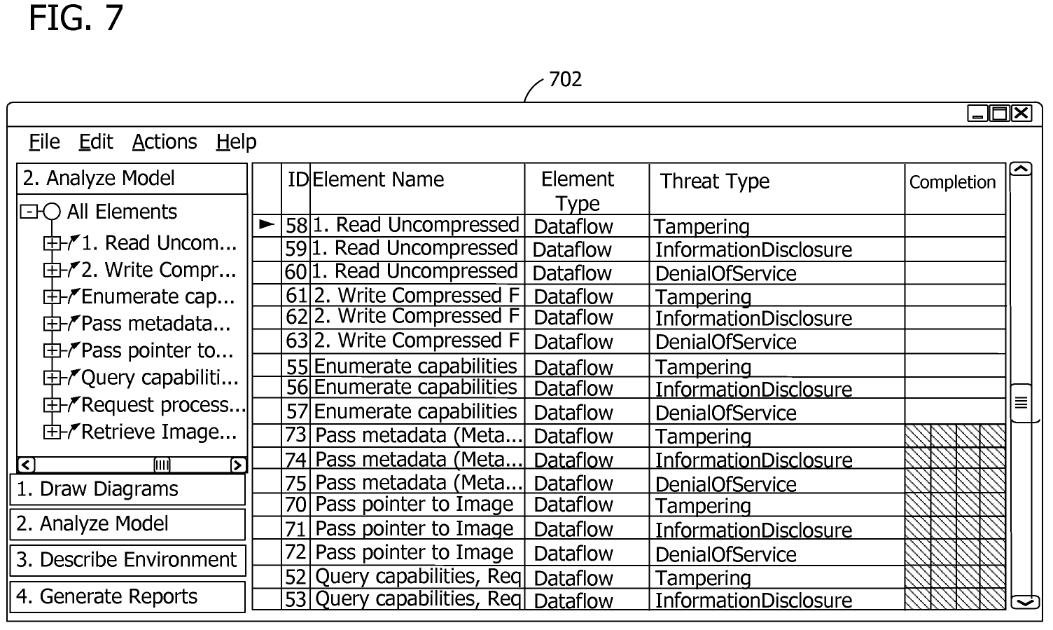

Referring next to FIG. 7, an exemplary user interface 702 illustrates a generated threat model including the elements 105 providing context as threats (e.g., the informational elements). The threat model in the user interface 702 in FIG. 7 lists the element names and corresponding element type, threat types, and completion progress bar. The inclusion of the informational elements in this report illustrates the explosion or proliferation of threats that distract the user 106 and reviewers of the threat model.

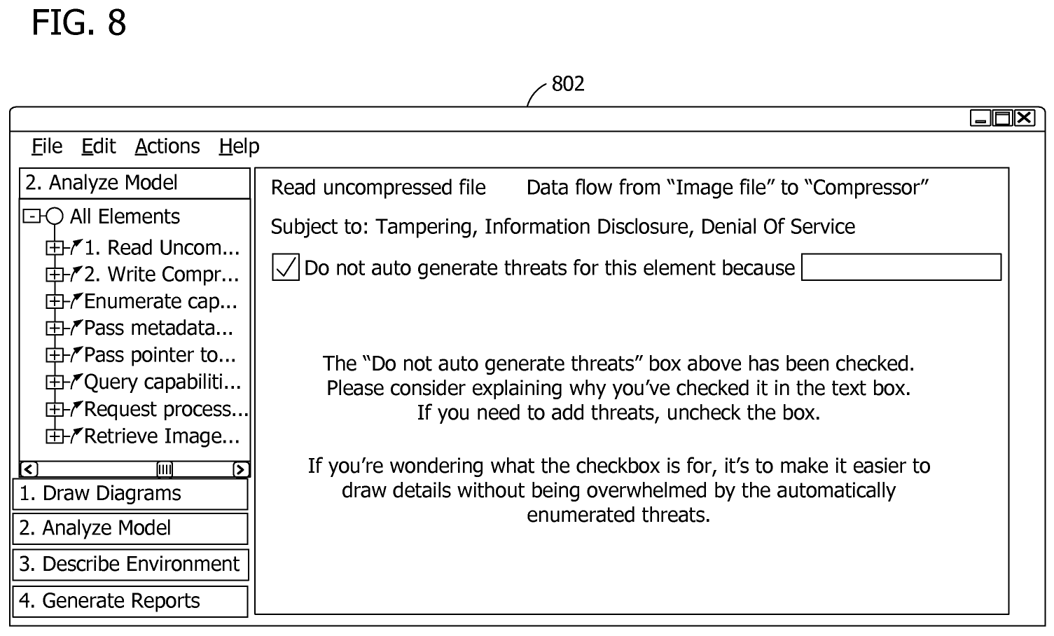

Referring next to FIG. 8, an exemplary user interface 802 illustrates the identification of the elements 105 providing context as informational elements. The user interface 802 in FIG. 8 includes a mechanism for the user 106 to mark and unmark elements 105 as informational. For example, the user 106 selects a checkbox to have the threat modeling system 102 exclude a particular one (or more) of the elements (e.g., an informational element) when generating the threat model. Alternatively or in addition, the user 106 may right-click on one of the elements 105 in the data flow diagram to select a property value or setting to designate the element 105 as an informational element.

While the example user interface 802 of FIG. 8 enables the threat modeling system 102 to exclude the informational elements when generating the threat model, aspects of the invention are operable with any form of differentiated treatment for the informational elements relative to the other elements 105. For example, the threat modeling system 102 may include the informational elements in the threat model report, but only list selected threat types for each of the informational elements. In another example, a tool for validating the structural integrity of the data flow diagram would not ignore the informational elements. Other modified behaviors of the threat modeling system 102 with respect to the informational elements are within the scope of embodiments of the invention.

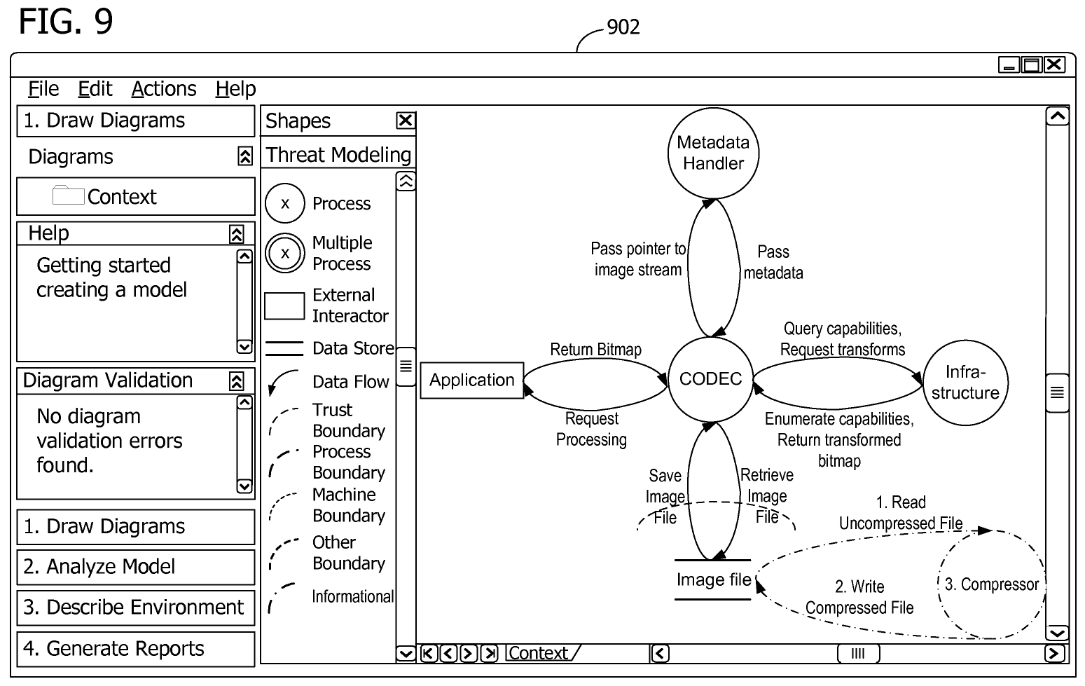

Referring next to FIG. 9, an exemplary user interface 902 illustrates the informational elements distinguished from the other elements 105 in the data flow diagram. After the informational elements have been identified, the user interface 902 displays the informational elements to the user 106 such that the user 106 may visually identify and distinguish the informational elements. In the example of FIG. 9, the informational elements are indicated by a dash-dot line.

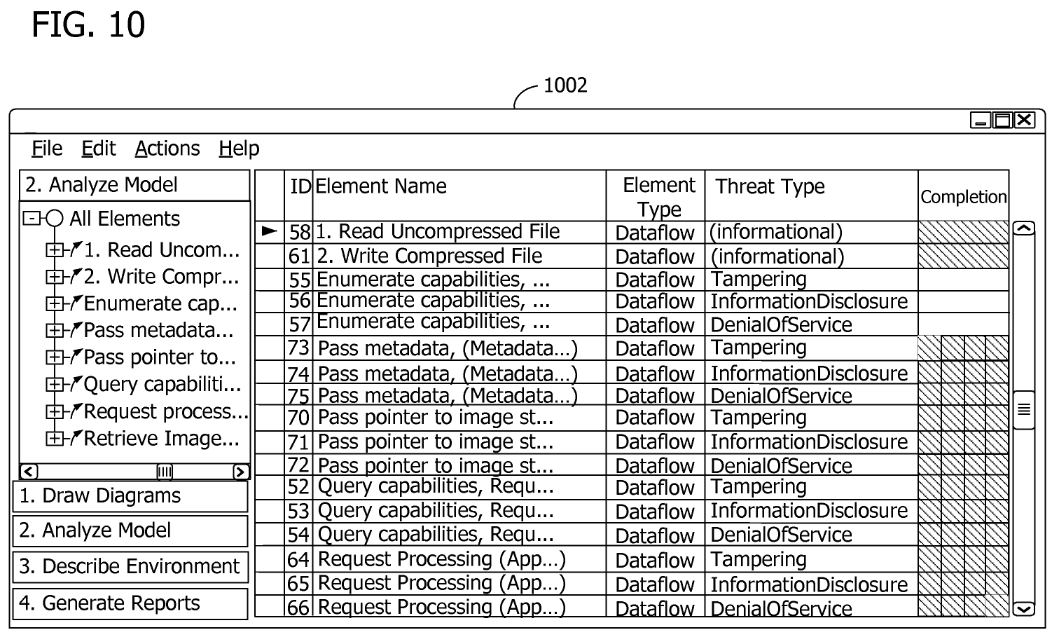

Referring next to FIG. 10, an exemplary user interface 1002 illustrates a generated threat model listing the elements 105 providing context as informational elements. As shown in the “threat type” column, the word “informational” indicates that the particular element 105 is an informational element. Correspondingly, the progress bar in the “completion” column is full (e.g., indicated completeness of the model for this element 105 and threat type).

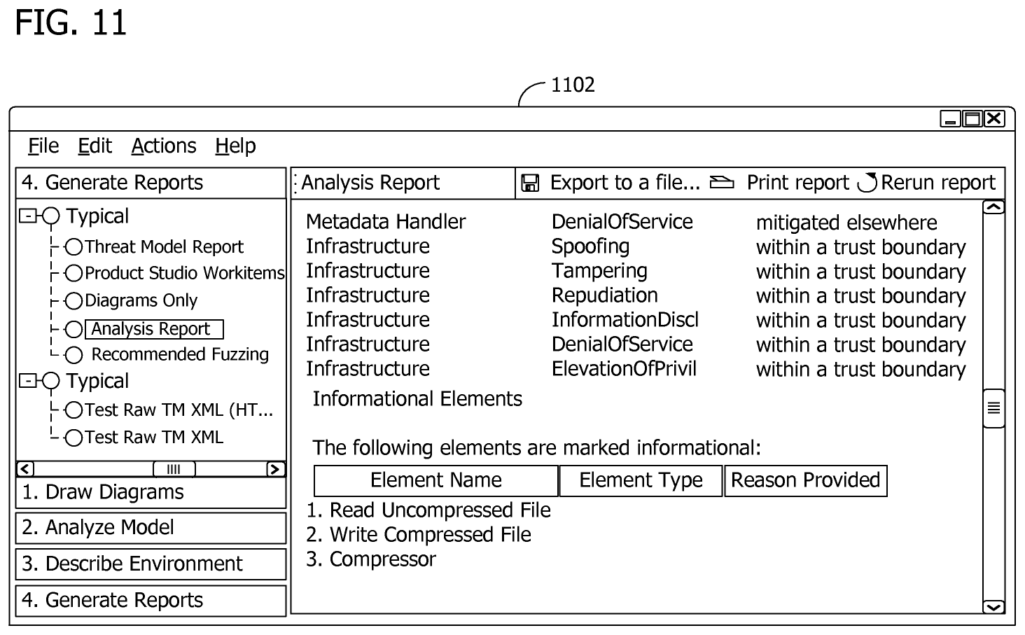

Referring next to FIG. 11, an exemplary user interface 1102 illustrates an analysis report with the informational elements listed separately from the other elements 105. In the example of FIG. 11, the threat modeling system 102 has considered the informational elements when preparing the threat model report, but has listed the informational elements separately from the other elements 105 to enable the user 106 to focus on the threats of interest.

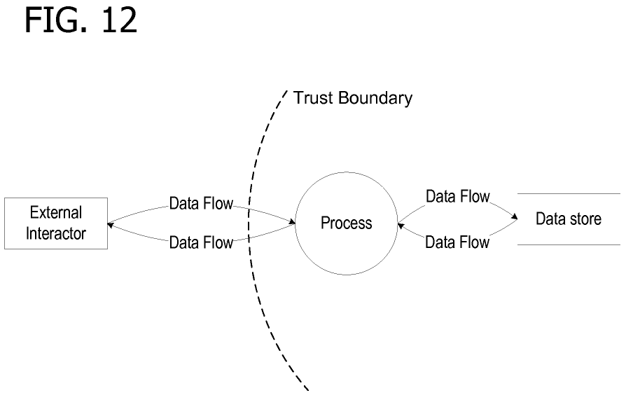

Referring next to FIG. 12, an exemplary block diagram illustrates a simple data flow diagram. An exemplary process of generating a threat model from the data flow diagram of FIG. 12 is described in Appendix B.

### Exemplary Operating Environment

A computer or computing device 202 such as described herein has one or more processors or processing units, system memory, and some form of computer readable media. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Communication media typically embody computer readable instructions, data structures, program modules, or other data in a modulated data signal such as a carrier wave or other transport mechanism and include any information delivery media. Combinations of any of the above are also included within the scope of computer readable media.

The computer may operate in a networked environment using logical connections to one or more remote computers, such as a remote computer. Although described in connection with an exemplary computing system environment, embodiments of the invention are operational with numerous other general purpose or special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of well known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein. Aspects of the invention may also be practiced in distributed computing environments where tasks are performed by remote processing devices that are linked through a communications network. In a distributed computing environment, program modules may be located in both local and remote computer storage media including memory storage devices.

The embodiments illustrated and described herein as well as embodiments not specifically described herein but within the scope of aspects of the invention constitute exemplary means for identifying the informational elements in the data flow diagram 104, and exemplary means for excluding from a threat model the informational elements in the data flow diagram 104.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

### Appendix A

The extensible markup language (XML) excerpt listed below includes a property identifying the element as an informational element.

```
  <Element Label=“User” ID=“0” ElementType=“Interactor”>
  <ConnectedEndpointCount>2</ConnectedEndpointCount>
  <CrossingBoundaryElementReferenceList />
  <Informational>true</Informational>
  <InformationalReason />
  <DiagramReferenceList>
  <DiagramReference Name=“Context” />
  </DiagramReferenceList>
  <ThreatList>
    <Threat ThreatType=“Spoofing”>
        <Id>1</Id>
    </Threat>
    <Threat ThreatType=“Repudiation”>
        <Id>2</Id>
    </Threat>
  </ThreatList>
</Element>
```

### Appendix B

The following operations describe an exemplary process for generating a threat model from a data flow diagram. Aspects of the invention are not limited to the operations or order of operations described herein. Rather, the process below merely provides an exemplary description of one method for generating the threat model. Other methods are contemplated.
1. Verify the data flow diagram's syntax and indicate errors if applicable.
2. Read the threat element types into memory from a common, shared dictionary stored in a memory area.
3. For each shape in the shape set:

a. Identify a threat element by:
i. Inferring the existence of an abstract threat “element” by type, connections, and name; or
ii. Correlating this shape with an existing abstract threat element as it shares type, name, and in cases of data flow shapes, connections, with the shapes corresponding to an existing element.

b. Assign a type to the threat element which corresponds exactly with the shape.

c. Threat elements are stored in memory in a temporary set.
4. Exemplary threat classifications and allowed associations with threat element types are read into memory from a common, shared dictionary stored on disk. The classifications and allowed associations are defined by, for example, a security expert or other user.
5. Threat elements have now been identified. For each threat element:

a. For each threat classification which applies:
i. Create a prototype threat. A threat is, abstractly, a collection of data including the below items. A prototype threat is one implementation of a threat; an object in memory which has the described fields and others as appropriate for structural and other purposes. The threat is created with a threat classification in an embodiment.
   1. A threat classification type.
   2. (optionally) A description of the nature of the threat.
   3. (optionally) A description of any mitigations which a threat modeler assigns to or describes for this threat.
   4. (optionally) A link to or index into a separate bug or work item tracking system. This link, index, or bug number identifies an issue or bug described in another system. Accordingly, threats described in threat models may be associated with parts of external systems and tracked or dealt with separately.
   5. (optionally) Metadata such as creation date, creator, links to other resources, etc.
ii. Threat classification guiding questions are read into memory from a common, shared dictionary stored on disk, network, or other media or location and read into memory. These questions, and sometimes statements or other prompts, are created, for example, by security experts (or created based on heuristics) and designed to provoke a response in the user creating and examining a complete threat model.
6. Users examine each threat model element via a user interface. The user may among other things:

a. Fill out a prototype threat with data.

b. Add additional threats and associate them to a threat element, provided they are of an allowed threat classification for the threat element's type. For example, the allowable threat classifications for an External Interactor are Spoofing (S) and Repudiation (R). A threat with a threat classification of Information Disclosure (D) could not be associated with an External Interactor, in some embodiments.

c. Remove threats or prototype threats, except that there must be at least one threat of each applicable threat classification associated with each element. If it would not make sense to have such a threat, users may certify the classification for that element.

d. Certify that a threat classification does not apply to a particular threat element. This happens in cases where it would not make sense. For example, the application threat classifications for a Data Store threat are Tampering, Repudiation, Information Disclosure, and Denial of Service. If a particular data store does not maintain records of specific transactions, it is not a log, then Repudiation threats would be meaningless and so the threat classification for Repudiation may be certified not to apply by a user, eliminating or hiding any threats or threat prototypes which may have been applied (erroneously or extraneously) to the data store.

e. Mark threat elements Informational.

An exemplary threat classification chart is shown in Table B1.

TABLE B1
Exemplary Threat Classifications.

| Goal | Threat | Explanation | Examples |
|---|---|---|---|
| Authentication | Spoofing | Impersonating | Pretending to be a particular |
| | | something or | user or domain |
| | | someone else. | |
| Integrity | Tampering | Modifying data | Modifying a DLL on disk or |
| | | or code | DVD, or a packet as it |
| | | | traverses the LAN. |
| Non- | Repudiation | Claiming to | “I didn't send that email,” “I |
| repudiation | | have not | didn't modify that file,” “I |
| | | performed an | certainly didn't visit that web |
| | | action. | site!” |
| Confidentiality | Information | Exposing | Allowing someone to read the |
| | Disclosure | information to | source code; publishing a list |
| | | someone not | of customers to a web site. |
| | | authorized to see it | |
| Availability | Denial of | Deny or degrade | Crashing a web site, sending a |
| | Service | service to users | packet and absorbing seconds |
| | | | of CPU time, or routing |
| | | | packets into a black hole. |
| Authorization | Elevation of | Gain capabilities | Allowing a remote internet |
| | Privilege | without proper | user to run commands, and |
| | | authorization | going from a limited user to admin. |

Examples software architecture components and their correspondence to data flow diagram elements are listed below.

External entity—people, systems out of scope, clouds, code not owned

Process—DLL/EXE, COM object, component service, code owned.

Data flow—function call, network traffic, shared memory, LPC and RPC.

Data Store—registry, file system, database, XML file

Trust boundary—machine boundary, process boundary, file system

Exemplary threat classifications corresponding to threat elements are shown in Table B2.

TABLE B2
Exemplary Threat Classifications Corresponding to Threat Elements.

| | | | | Information | Denial of | Elevation of |
|---|---|---|---|---|---|---|
| | Spoofing | Tampering | Repudiation | Disclosure | Service | Privilege |
| Process | X | X | X | X | X | X |
| External | X | | X | | | |
| Entity | | | | | | |
| Data | | X | X | X | X | |
| Store | | | | | | |
| Data | | X | | X | X | |
| Flow | | | | | | |

Appendix C includes an example of a data flow diagram and the threat model automatically generated from it.

Exemplary threat classifications that apply to common data flow diagram elements are shown below.

Data flow elements: tampering, information disclosure, and denial of service

Data store elements: tampering, repudiation, information disclosure, and denial of service

External interactor elements: spoofing, repudiation

Process elements: spoofing, tampering, repudiation, information disclosure, denial of service, and elevation of privilege

### Appendix C

The exemplary threat model report for the sample data flow diagram in FIG. 12 is shown below. The threat model report includes uncompleted areas. The user or other modeler completes the description of the threat types and more to complete the threat model. The headings in the exemplary threat model report include the following: threat model information, data flow diagrams, threats and mitigations, external dependencies, implementation assumptions, and external security notes.

Exemplary threats and mitigations based on FIG. 12 are shown in Table C1 below.

TABLE C1
Exemplary Threats and Mitigations for Data Flow Diagram of FIG. 12.

| Element Type | Description |
|---|---|
| Data Flow | commands |
| Data Flow | configuration |
| Data Flow | responses |
| Data Flow | results |
| Data Store | data |
| Interactor | User |
| Process | My process |
| TrustBoundary | |

The exemplary threat model report lists the following element names and corresponding threat types.

```
External Interactors
User
    Threats:
        Spoofing
            Threat #1:
            Mitigation #1:
        Repudiation
            Threat #2:
            Mitigation #2:
Processes
My process
    Threats:
        Spoofing
            Threat #15:
            Mitigation #15:
        Tampering
            Threat #16:
            Mitigation #16:
        Repudiation
            Threat #17:
            Mitigation #17:
        Information Disclosure
            Threat #18:
            Mitigation #18:
        Denial of Service
            Threat #19:
            Mitigation #19:
        Elevation of Privilege
            Threat #20:
            Mitigation #20:
Multi-Processes
Data Flows
Commands
    Threats:
        Tampering
            Threat #3:
            Mitigation #3:
        Information Disclosure
            Threat #4:
            Mitigation #4:
        Denial of Service
            Threat #5:
            Mitigation #5:
Configuration
    Threats:
        Tampering
            Threat #9:
            Mitigation #9:
        Information Disclosure
            Threat #10:
            Mitigation #10:
        Denial of Service
            Threat #11:
            Mitigation #11:
Responses
    Threats:
        Tampering
            Threat #6:
            Mitigation #6:
        Information Disclosure
            Threat #7:
            Mitigation #7:
        Denial of Service
            Threat #8:
            Mitigation #8:
Results
    Threats:
        Tampering
            Threat #12:
            Mitigation #12:
        Information Disclosure
            Threat #13:
            Mitigation #13:
        Denial of Service
            Threat #14:
            Mitigation #14:
Data Stores
Data
    Threats:
        Tampering
            Threat #21:
            Mitigation #21:
        Repudiation
            Threat #22:
            Mitigation #22:
        Information Disclosure
            Threat #23:
            Mitigation #23:
        Denial of Service
            Threat #24:
            Mitigation #24:
```

What is claimed is:

1. A system for excluding selected data flow diagram elements from a threat model report, said system comprising:
a memory area for storing a representation of a data flow diagram for an information system, said data flow diagram comprising a plurality of elements arranged to describe a flow of data through the information system, wherein one or more of the plurality of elements include informational elements; and
a processor programmed to:
receive identification of one or more of the plurality of elements as informational elements;
provide a visual representation of the data flow diagram for display;
indicate the informational elements in the visual representation of the data flow diagram based on the received identification;
receive a request from a user for a threat model;
create a subset of the plurality of elements by excluding the informational elements from the plurality of elements; and
provide the created subset of the plurality of elements to an automated threat modeling system, wherein the automated threat modeling system generates a threat model based on the created subset of the plurality of elements.

2. The system of claim 1, wherein the processor is further programmed to store the received identification as a property value associated with each of the corresponding one or more of the plurality of elements.

3. The system of claim 2, wherein the processor is further programmed to store the property value in an extensible markup language file.

4. The system of claim 1, wherein the processor is further programmed to indicate the informational elements in the visual representation of the data flow diagram by visually distinguishing the informational elements from the created subset of the plurality of elements.

5. The system of claim 1, further comprising means for excluding from a threat model the informational elements in the data flow diagram.

6. The system of claim 1, further comprising means for identifying the informational elements in the data flow diagram.

7. A method comprising:
accessing a representation of a data flow diagram for an information system, said data flow diagram comprising a plurality of elements arranged to describe a flow of data through the information system;
generating a threat model based on the plurality of elements;
selecting one or more elements from the plurality of elements as informational elements;
identifying the informational elements in the generated threat model; and
providing the generated threat model with the identified informational elements to a user for analysis.

8. The method of claim 7, further comprising creating a subset of the plurality of elements in the generated threat model by excluding the selected one or more informational elements from the plurality of elements in the generated threat model.

9. The method of claim 7, further comprising receiving identification of the informational elements from the user.

10. The method of claim 7, wherein the data flow diagram is stored as an object model, and further comprising receiving identification of the informational elements from the object model.

11. The method of claim 7, wherein the selected informational elements provide contextual information for the information system.

12. The method of claim 7, wherein each of the informational elements comprise one or more of the following: a data flow element, a data store element, a process, or an external interactor.

13. One or more computer-readable media having computer-executable components for marking elements in a data flow diagram as informational, said components comprising:
an interface component for accessing a representation of a data flow diagram for an information system, said data flow diagram comprising a plurality of elements arranged to describe a flow of data through the information system, wherein the plurality of elements include one or more elements marked as informational;
a type component for identifying, from the plurality of elements, one or more data flow elements adjacent to the one or more elements marked as informational;
a decision component for determining whether the data flow elements identified by the type component cross a trust boundary; and
a propagation component for indicating the data flow elements as informational based on the determination by the decision component.

14. The computer-readable media of claim 13, wherein the propagation component marks the data flow elements that cross the trust boundary as informational.

15. The computer-readable media of claim 13, wherein the interface component provides the data flow diagram to a user for display.

16. The computer-readable media of claim 13, wherein the propagation component indicates the data flow elements as informational by setting a property value for each of data flow elements in an object model.

17. The computer-readable media of claim 13, wherein the plurality of elements indicated to be informational convey contextual information for the information system.

18. The computer-readable media of claim 13, further comprising a report component for generating a threat model for each of the plurality of elements.

19. The computer-readable media of claim 18, wherein the elements indicated to be informational are distinguished in the threat model from the other elements.

20. The computer-readable media of claim 13, wherein the decision component determines whether each of the data flow elements identified by the type component crosses a trust boundary by determining whether a level of trust changes across the data flow element.
